(19) United States
(12) Patent Application Publication
(10) Pub. No.: US 2009/0027070 A1
(43) Pub. Date: Jan. 29, 2009

(54) ELECTROCHEMICAL IMPEDANCE SPECTROSCOPY METHOD AND SYSTEM

(75) Inventor: Victoria Johnston Gelling, Fargo, ND (US)

Correspondence Address: JOHN P. O'BANION;O'BANION & RITCHEY LLP, 400 CAPITOL MALL SUITE 1550, SACRAMENTO, CA, 95814, US

(73) Assignee: NDSU RESEARCH FOUNDATION, Fargo, ND (US)

(21) Appl. No.: 12/174,540

(22) Filed: Jul. 16, 2008

Related U.S. Application Data
(63) Continuation of application No. PCT/US2007/062130, filed on Feb. 14, 2007.
(60) Provisional application No. 60/773,469, filed on Feb. 14, 2006.

(51) Int. Cl. G01N 27/02

(52) U.S. Cl. 324/693

(57) ABSTRACT

A dual cell Electrochemical Impedance System (EIS) testing apparatus and method for measuring coating integrity on various substrates. The counter reference electrode is in a first cell in electrical contact with the coating. The working electrode is in a second cell in electrical contact with the coating instead of the substrate material acting as the working electrode. Voltage is applied at the working electrode at varying frequencies and current is measured at the combined reference/counter electrode. From the known voltage and the measured current, the impedance of the coating is calculated. Coatings on non-metallic substrates can be measured with this apparatus. In one embodiment, the EIS cells are in the form of vacuum cups containing an electrolyte gel for testing non-horizontal coatings in the field. Also, known current can be applied to the working electrode and voltage measured at the counter reference electrode can be used to calculate coating impedance.

### CROSS-REFERENCE TO RELATED APPLICATIONS

This application claims priority from, and is a 35 U.S.C. § 111 (a) continuation of, co-pending PCT international application serial number PCT/US2007/062130, filed on Feb. 14, 2007, incorporated herein by reference in its entirety, which claims priority from U.S. provisional application Ser. No. 60/773,469, filed on Feb. 14, 2006, incorporated herein by reference in its entirety.

### STATEMENT REGARDING FEDERALLY SPONSORED RESEARCH OR DEVELOPMENT

This invention was made with Government support under Grant No. W911NF-04-2-0029, awarded by the Army Research Laboratory. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to Electrochemical Impedance Spectroscopy (EIS), and more particularly to two electrode EIS for measuring the integrity of a coating without contacting the substrate.

2. Description of Related Art

Corrosion is a major problem when designing building structures, automobiles, and aircraft. On average, the problems caused by corrosion cost the United States about 3-5% of the gross national product per year. The United States Army estimates that it spends $20 billion per year on corrosion. Due to this fact, large amounts of money are being spent on corrosion protective coatings research.

An important aspect of the maintenance schedule of any structure that is exposed to the environment is the detection of corrosion, which could potentially lead to failure. The most common way to protect against corrosion is to apply protective coatings to the substrate. There are a wide variety of coating systems that can be used to protect the many different engineering materials that are used. Some of the systems include organic coatings, metal rich coatings, such as zinc rich coating, and powder coatings. Determining coating integrity and the corrosion protection the coatings provide to the substrate is a relatively simple procedure in the lab. However field-testing coatings for corrosion protection is relatively more difficult. Detecting corrosion on test panels in the lab is done using Electrochemical Impedance Spectroscopy (EIS), Electrochemical Noise Measurements (ENM), or Open Circuit Potential (OCP).

FIG. 1 illustrates a schematic of the traditional EIS measurement system 10 consisting of a three-electrode setup. The panel 12 to be tested consists of a coating 14 applied to a conductive substrate 16. A platinum counter electrode 18 and a saturated calomel reference electrode 20 are placed into a solution 22 contained in a vessel or piece of glassware 24 that is clamped to the coating 14 of test panel 12. The solution or the electrolyte 22 in vessel 24 is traditionally dilute Harrison solution (0.35% (NH₄)₂SO₄ & 0.05% NaCl) or another salt solution such as 5% NaCl. The third electrode or working electrode 26 is coupled to the substrate 16 to which the coating 14 is applied. Substrate 16 can be a variety of conductive material, such as steel, aluminum, magnesium, bronze and many other metals. During the measurement, a small AC voltage perturbation is applied to the working electrode 26 over a frequency range. The current that is able to be pushed through the coating 14 is then measured at the counter electrode 18. From the known voltage and measured current, an impedance of coating 14 is calculated and stored for the different frequencies. The range of frequencies typically used in EIS can be from about 0.01 Hz to about 10⁵ Hz. Mid-range EIS measurements are taken in the range of about 0.1 Hz to about 10 Hz.

The calculation that is performed is a simple Ohm's law calculation where Z is the impedance in the equation V=IZ, which is analogous to R, the resistance, in the equation V=IR. The applied voltage and the current measurements are completed using a potentiostat such as a Gamry Potentiostat.

From the calculated impedance, the coating integrity and the corrosion protection that it offers can be quantified. In general, the higher the impedance the better corrosion protection the coating offers.

FIG. 2 illustrates a Bode Plot of impedance measured at different frequencies for a coating experiencing exposure to a corrosive substance over a period of time. Typically, these measurements are taken as described in FIG. 1. A computer is typically connected to the potentiostat and used to calculate impedance and produce the Bode plot as a display, printout or stored data.

Another analysis technique that can used to determine a coating's behavior is equivalent circuit modeling. Using these models, coating behavior such as inductance, capacitance and diffusion can be modeled with the different circuit element and a value for each circuit component is given.

Although the traditional EIS testing method is a very reliable and trusted technique for laboratory testing of coatings there are some limitations when this techniques is used for field testing of coatings. These limitations include a required electrical connection to the substrate which results in local coating destruction. Another limitation is a connection to the substrate that is a relatively long distance away from the tested area which could create noisy data and inaccurate readings. An example of this would be attaching a test cell to the wing of an aircraft and making the connection to the substrate at the landing gear where bare substrate is exposed. Coatings with non-metallic substrates cannot be measured by this method. Another problem with traditional EIS is that due to the nature of the electrolyte solution in the glassware, only horizontal surfaces can be tested.

### BRIEF SUMMARY OF THE INVENTION

To overcome the limitations described above, a new dual cell EIS testing system and method has been developed for measurement of coating integrity on various substrates. This technique specifically enables easy measurements in the field and various embodiments can be used on non-horizontal coating surfaces and on non-conducting substrates. The counter reference electrode is in a cell in electrical contact with the coating. The working electrode is in a second cell in electrical contact with the coating instead of the substrate material acting as the working electrode. Voltage is applied at the working electrode and current is measured at the combined reference/counter electrode. From the known voltage and the measured current the impedance of the coating is calculated. An embodiment of the invention is an apparatus for measuring impedance of a coating on a substrate that comprises a first cell chamber, where the first cell chamber has a first opening, a counter-reference electrode positioned in the first cell chamber, a second cell chamber, where the second cell chamber has a second opening, a working electrode positioned in the second cell chamber, an electrolyte positioned in the first, second cell chambers, where the electrolyte is in electrical contact with the counter-reference electrode in the first cell chamber, where the electrolyte is in electrical contact with the working electrode in the second cell chamber, means for securing the first opening and the second opening to a coating, where the electrolyte makes electrical contact with the coating when the first opening and the second opening are in contact with the coating by the means for securing, a potentiostat electrically connected to the counter-reference electrode and to the working electrode, where the potentiostat is adapted to apply alternating voltage at varying frequencies to the working electrode and measure current at the counter-reference electrode, means for calculating impedance from measured current, and means for outputting impedance.

An aspect of the invention is where the distance between the counter-reference electrode and the coating is adjustable, and where the distance between the working electrode and the coating is adjustable.

Another aspect of the invention is where the counter reference electrode comprises a niobium platinum plated mesh, and where the working electrode comprises a niobium platinum plated mesh.

A further aspect of the invention is where the means for securing is adapted to secure the first opening and the second opening to a non-horizontal coating.

Another aspect of the invention is where the electrolyte comprises a conductive gel.

A further aspect of the invention is where the means for securing comprises a frame supporting the first cell chamber and the second cell chamber, a spring loaded plunger connected to the frame, and a base connected to the spring loaded plunger, where the base is adapted to support a coated substrate.

A yet further aspect of the invention is where the distance between the first cell chamber and the second cell chamber is adjustable.

Another aspect of the invention is where the means for securing comprises a first vacuum cup coupled to the reference counter electrode, and a second vacuum cup coupled to the working electrode.

A further aspect of the invention is where the potentiostat is adapted to apply alternating current at varying frequencies to the working electrode, where the potentiostat is further adapted to measure voltage at the counter-reference electrode, and means for calculating impedance from measured voltage.

A still further aspect of the invention is where the first cell chamber comprises a cavity in a first body, where the first opening comprises a first O-ring mounted in the first body, where the second cell chamber comprises a cavity in a second body, and where the second opening comprises a second O-ring mounted in the second body.

Another aspect of the invention is where the first cell chamber comprises a first vacuum cup, and where the second cell chamber comprises a second vacuum cup.

A further aspect of the invention is where the counter reference electrode comprises stainless steel, and where the working electrode comprises stainless steel.

Another embodiment of the invention is an apparatus for measuring the impedance of a coating on a substrate that comprises a first vacuum cup having a first cavity, a counter-reference electrode positioned in the first cavity, a second vacuum cup having a second cavity, a working electrode positioned in the second cavity, an electrolyte positioned in the first, second cavities, the electrolyte adapted to conduct electricity between a coating and an electrode, a potentiostat electrically connected to the counter-reference electrode and the working electrode, where the potentiostat is adapted to apply alternating current at varying frequencies to the working electrode and measure potential at the counter-reference electrode, means for calculating impedance from measured potential, and means for outputting impedance.

Another aspect of the invention is where the first, second vacuum cups are adapted to couple to a non-horizontal coating.

Another embodiment of the invention is an electrode cell for measuring impedance of a coating on a substrate that comprises a planar vacuum cup base having a first aperture, a resilient vacuum pad having first and second sides, the first side adapted to mate with the planar vacuum cup base, the second side of the vacuum pad having a concave cavity, a second aperture in the vacuum pad adapted to align with the first aperture, an electrode comprising a disk and perpendicular stem, the disk of the electrode adapted to fit inside the concave cavity of the vacuum pad, the stem of the electrode adapted to fit in the first aperture and the second aperture, where the stem is further adapted to couple the vacuum pad to the vacuum base, the stem adapted to electrically connect to a potentiostat, an electrolyte positioned in the concave cavity, the electrolyte adapted to conduct electricity between a coating and the electrode, where when the concave cavity of the vacuum pad containing the electrolyte is positioned on a coating, the electrode makes electrical contact with the coating through the electrolyte.

Another aspect of the invention is where moving the electrode away from the coating relative to the vacuum cup base forms a vacuum between the concave cavity and the coating.

A further aspect of the invention is where the vacuum pad is adapted to releasably couple to a non-horizontal coating.

A further embodiment of the invention is a method of measuring impedance of a coating on a substrate that comprises providing a first electrode chamber having a counter-reference electrode and an electrolyte in the chamber, providing a second electrode chamber having a working electrode and an electrolyte in the chamber, providing a potentiostat adapted to apply alternating voltage at varying frequencies to the working electrode and measure current at the counter-reference electrode, coupling the first and second electrode chamber to a coating where the electrolyte makes electrical contact with the coating, applying alternating voltage at varying frequencies to the working electrode, measuring current at the counter-reference electrode, calculating impedance from the measured current, and outputting impedance to interpret coating integrity.

A further aspect of the invention is where the potentiostat is adapted to apply alternating current at varying frequencies to the working electrode and measure voltage at the counter-reference electrode, measuring voltage at the counter reference electrode, and calculating impedance from the measured voltage.

A still further aspect of the invention is coupling the first, second chamber to a non-horizontal coating.

Another aspect of the invention is where the first electrode chamber comprises a first vacuum cup, and where the second electrode chamber comprises a second vacuum cup.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic illustration of a traditional three electrode Electrochemical Impedance Spectroscopy (EIS) system.

FIG. 2 is an example Bode plot of impedance of a coating measured at different frequencies with a traditional EIS system where the coating is exposed to corrosion over a period of time.

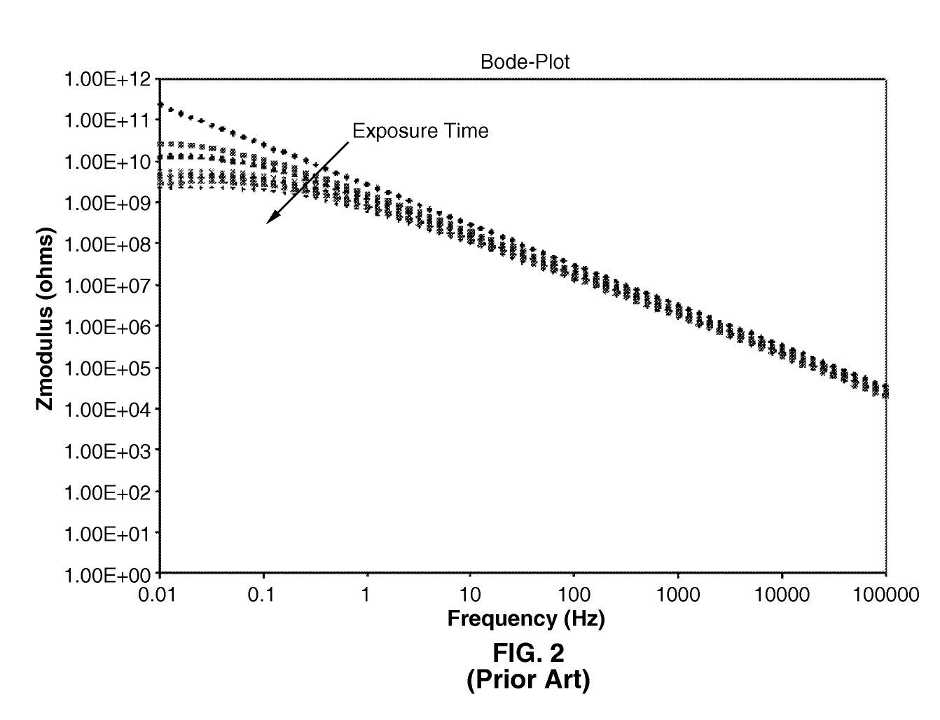

FIG. 3 is a schematic illustration of a dual cell EIS.

FIG. 4 is a Bode plot illustrating the proof of concept of the dual cell EIS illustrated in FIG. 3.

FIG. 5 is an exploded view of one cell in a dual cell EIS system.

FIG. 6 is a front view of a dual cell EIS system.

FIG. 7 is a front view of a dual cell EIS fixture as shown in FIG. 6 positioned to measure the impedance of a coating on a sample panel.

FIG. 8 is an exploded view of one electrode cell of a dual cell EIS system used to measure coating integrity in a field environment.

FIG. 9 illustrates a dual cell EIS system as shown in FIG. 8 positioned to measure impedance of a coating in the field.

### DETAILED DESCRIPTION OF THE INVENTION

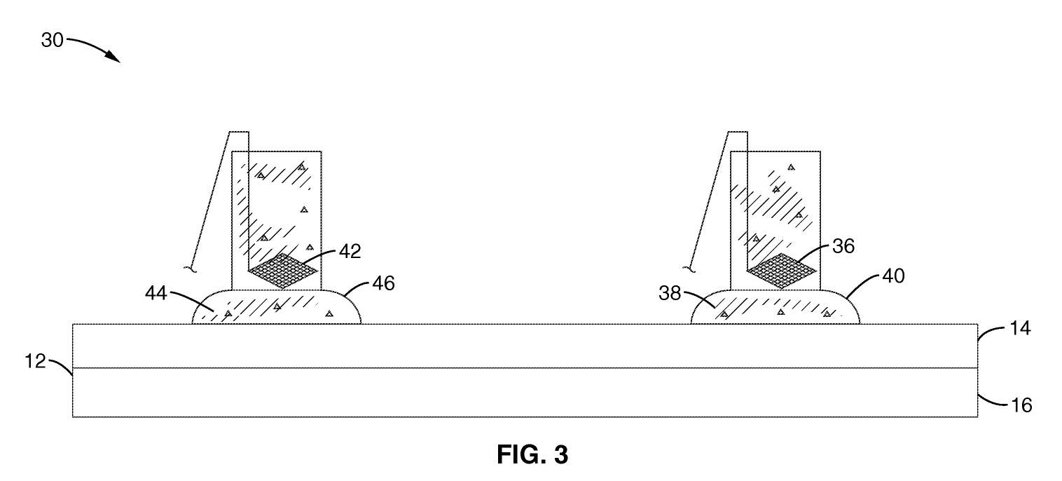

Referring more specifically to the drawings, for illustrative purposes the present invention is embodied in the apparatus generally shown in FIG. 3 through FIG. 8. It will be appreciated that the apparatus may vary as to configuration and as to details of the parts, and that the method may vary as to the specific steps and sequence, without departing from the basic concepts as disclosed herein.

In order for EIS measurements to become a reliable technique for corrosion field testing a new two electrode testing technique has been developed.

FIG. 3 is a schematic illustration of a dual cell electrode system 30. Panel 12 has a coating 14 applied to substrate 16. Working electrode 36 is suspended in an electrolyte 38 in a vessel 40 made of a non-conducting material such as glass. The bottom of vessel 40 and electrolyte 38 are in direct contact with coating 12. Working electrode 36 does not contact substrate 14. A counter-reference electrode 42 is suspended in electrolyte 44 in vessel 36. The bottom of vessel 46 and electrolyte 44 are in direct contact with coating 12. In a preferred embodiment, electrolytes 38 and 44 are the same substance and electrodes 36 and 42 are platinum plated niobium mesh.

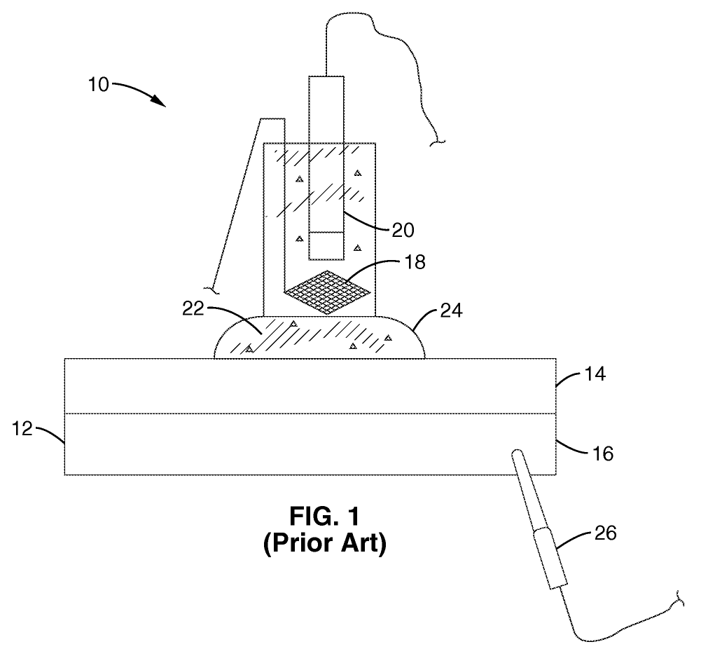

Instead of the substrate material 16 acting as the working electrode, in dual cell testing the working electrode is a platinum plated electrode 36. In a potentiostatic mode, constant voltage at varying frequencies is applied and the resulting current is measured at the combined reference-counter electrode 42 which is another platinum plated electrode. From the known voltage and the measured current the impedance of the coating is calculated as described previously in FIG. 1. A galvanostatic mode can also be applied where constant current at varying frequencies is applied and the resulting voltage is measured at the reference-counter electrode.

One of the advantages of this new technique is that no electrical connection to the substrate is needed, which will result in no need for local coating destruction. This new technique also makes EIS measurements possible for large objects, thus making it possible to design a portable EIS corrosion testing instrument. Another advantage of this technique is the substrate no longer needs to be conductive allowing for coating integrity to be measured on wood, plastic, and other non-conductive substrates.

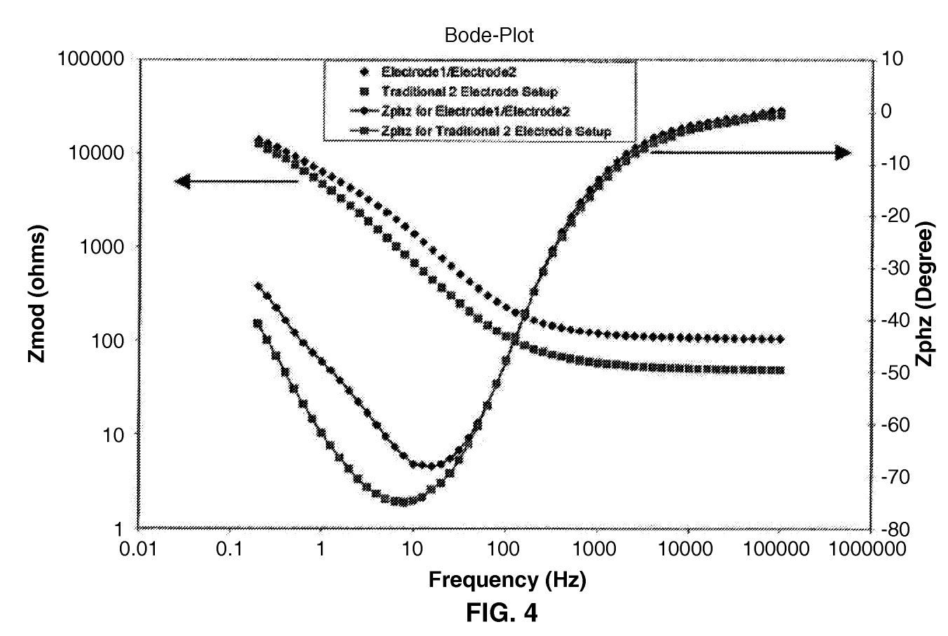

FIG. 4 is a Bode plot illustrating the proof of concept for the invention. Measurements were taken on Aluminum 2024-T3 purchased from Q-Panel. The potentiostat used was a Gamry model PC-4. The test parameters were: Scan range 100,000 Hz to 0.2 Hz; AC perturbation 10 mV; DC offset 0V versus Eoc.

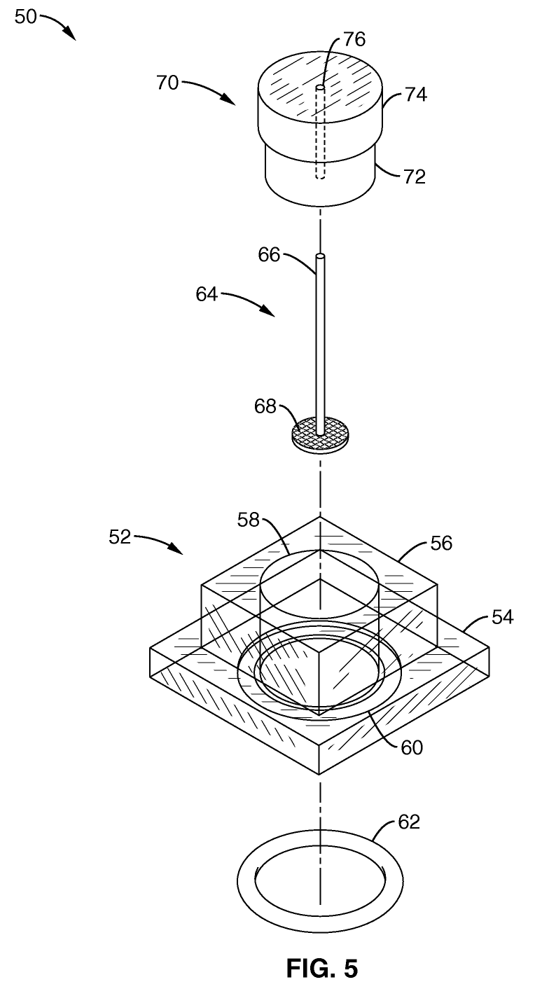

FIG. 5 is an exploded view of one electrode cell 50 of a dual cell EIS system used to measure coating integrity in a laboratory environment. Electrode cell 50 has a body 52 made of non-conductive material such as acrylic. In this embodiment, body 52 has rectangular base 54 and rectangular top 56 milled from a single piece of material. Aperture 58 extends vertically through body 52. O-ring groove 60 is positioned around aperture 58 in the bottom face of base 54 and supports O-ring 62. O-ring 62 is adapted to seal aperture 58 when the bottom of base 54 is pressed against a coating on a flat panel.

Electrode 64 has a stem 66 and a mesh disk 68. In a preferred embodiment, disk 68 is a niobium platinum plated mesh. Insert 70 has cylindrical base 72 that fits tightly into aperture 58. Cap 74 of insert 70 has an outside diameter larger than aperture 58. A bore 76 extends through the center of insert 70 and receives stem 66 with an interference fit. The preferred material for the insert 70 is a non-conducting material such as ultra high molecular weight polyethylene (UHMWPE).

The preferred materials for this embodiment of electrode cell 50 were chosen for their low cost, extremely high resistivities, and aesthetics of the design. Acrylic in particular is easily machined, and offers a glasslike final appearance. The resistivity of this material is between 10¹⁴→10¹⁵ Ω-cm and the resistivity of UHMWPE is between 10¹⁵→10¹⁸ Ω-cm. These resistivities are much higher than the resistances of a typical coating that will be measured. Coating resistances are generally in the range of 10⁹→10¹⁰ Ω-cm.

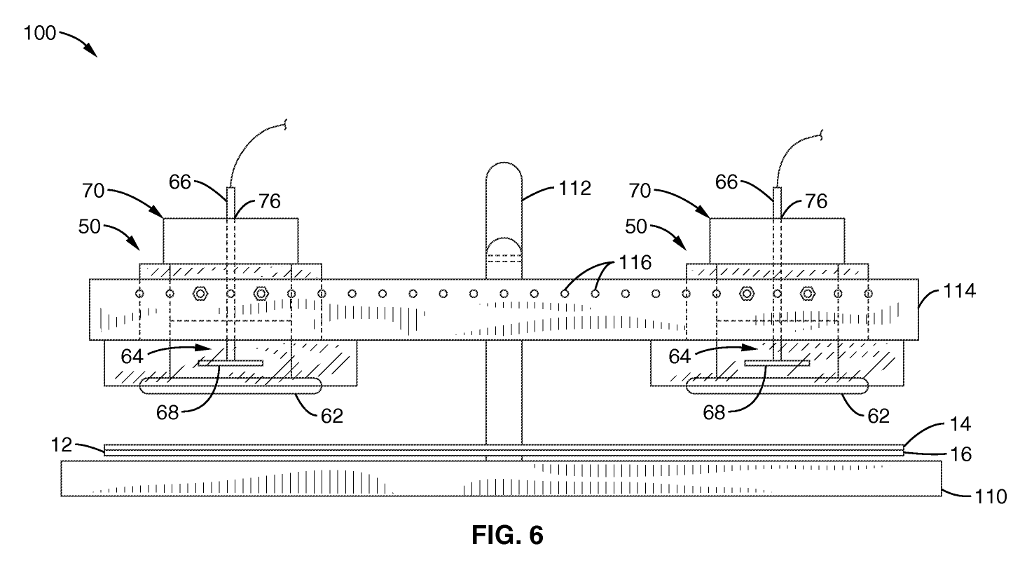

FIG. 6 is front view of a dual cell EIS fixture 100 assembled with dual electrode cells 50 to measure integrity of a coating. In one mode, this embodiment is used to measure the integrity of a coating on an exemplar or sample plate in the laboratory. Dual cell fixture 100 is supported on a planar non-conducting base 110 made of material such as UHMWPE. Base 110 supports a panel 12 with coating 14 to be measured and substrate 16.

A spring loaded plunger 112 is mounted to base 110 and supports perforated frame 114 having regularly spaced apertures 116. Two electrode cells 50 as shown previously in FIG. 4 are mounted on perforated frame 114, typically equidistant from the center. Prior to connecting the electrodes, electrode cells 50 are interchangeable. Horizontal spacing of electrode cells 50 can be adjusted by aligning the cells with different apertures 116 in frame 114. Vertical spacing of mesh disk 68 of electrodes 64 is accomplished by adjusting the interference fit of stem 66 in bore 76 of insert 70. These adjustments can be critical when matching test outcomes of coating integrity with the replicable results on sample panels.

In one embodiment, dual cell EIS fixture 100 is sized to fit within existing faraday cages. In a further embodiment, dual cell EIS fixture 100 is sized to measure 3″ by 6″ CARC coated steel panels or bare aluminum panels of identical size. These fixtures are also configured to be portable in a laboratory environment and accommodate rapid test panels changes.

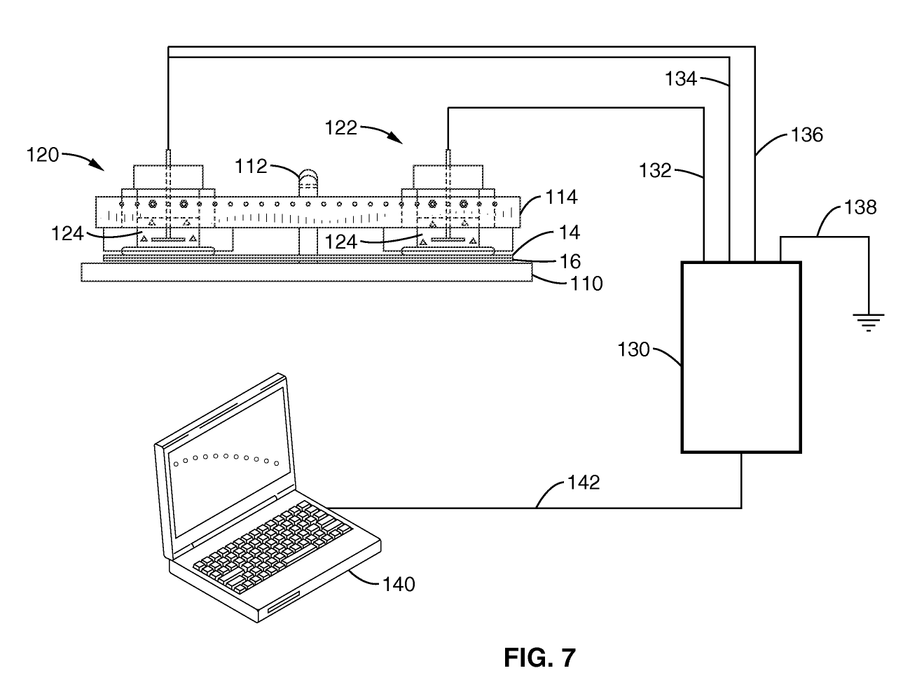

FIG. 7 illustrates dual cell EIS fixture 100 positioned to measure integrity of coating 14 on panel 12. Cell 120 is now designated as the counter-reference electrode and cell 122 is designated as the working electrode. An electrolyte 124 is placed in the cavity of each cell 120, 122 and cells 120, 122 are placed in contact with coating 12 by moving frame 114 down with spring loaded plunger 112. Note the electrolyte can be added to cells 120, 122 after contact with the coating by removing insert 70 shown in FIG. 6.

A potentiostat 130 has working electrode lead 132 connected to the electrode in cell 122, counter electrode lead 134 connected to the electrode in cell 120 and reference electrode lead 136 connected to the electrode in cell 120. Potentiostat 130 also has a ground lead 138. In a first potentiostatic mode, potentiostat 130 applies a potential or voltage at varying frequencies through working electrode lead 132 and measures the resulting current. In a second galvanostatic mode, potentiostat 130 applies a current through working electrode lead 132 at varying frequencies and measures the resulting potential or voltage.

Potentiostat 130 is connected to computer 140 through connection 142. Computer 140 is configured to calculate impedance from the measurements from potentiostat 130 and output the results as a display, such as a Bode plot, equivalent circuit or other analytical format such as electronic data that can be stored in memory and used to interpret the integrity of coating 14. In one mode, a controller card is placed in computer 140 to receive signals through connection 142.

A method of using dual cell fixture 100 is to first place a panel 12 having a coating 14 on a substrate 16 on base 110. Next, place an electrolyte or electrolyte gel 124 in the cavity of electrode cells 120 and 122 immersing the electrodes within. Move spring loaded plunger 112 and perforated frame 114 downward until the O-rings press against coating 14 on panel 12 and the electrolyte 124 inside cells 120, 122 makes a conductive connection with the electrodes and coating 14. Connect the electrode of cell 122 to the working lead 132 of potentiostat 130. Connect the electrode of cell 120 to the counter lead 134 and reference lead 136 of potentiostat 130. In one mode, apply a potential over varying frequencies through working electrode lead 132 and measure the resulting current at counter electrode lead 134. In another mode, apply a current of varying frequencies through working electrode lead 132 and measure the resulting potential at counter electrode lead 134. Calculate the impedance of coating 14 over the varying frequencies and output the measurements of impedance to determine the integrity of coating 14.

In measuring coatings using EIS techniques, it is important that the electrode cells remain in position and in electrical contact with the coating until all the measurements over the range of frequencies are completed. Movement of the electrode position relative to the coating or each other, or changes in conductivity between the electrode and coating will result in inaccurate measurements. Handheld electrodes that contact the coating directly are not suitable to obtain accurate EIS measurements since electrode position and resultant conductivity cannot be reliably held constant over the time necessary to complete current and potential measurements at the low frequencies. Electrodes that contact the coating can also scratch, pierce, or damage the coating during measurement producing inaccurate results.

The surface of the coating to be tested is assumed to be smooth and free of chips or other imperfections. Visible imperfections are signs of coating failure and therefore the use of EIS testing in this case in unnecessary. The substrate material can be any type of material, including but not limited to ferrous, non ferrous, metal, wood, plastic, and even organic materials.

Although electrolyte solutions such as Harrison's solution are suitable as the electrolyte 124, Electrolyte gels can also provide the necessary conductivity for a dual cell EIS system. Examples include Signa Electrode Gel™ and Spectra 360™, both made by Parker Laboratories. The advantage of electrolyte gels is that the EIS cells can be positioned in non-horizontal positions without the risk of spillage or leakage of electrolyte.

Note that the base 110 and spring loaded plunger 112 of dual cell fixture 100 in FIG. 6 can removed and frame 114 positioned on large flat objects to test the integrity of the coating. Furthermore, substituting a suitable clamp or support device for spring loaded plunger 112, and using an electrolyte gel 124 would allow dual cell fixture 100 to be used on non-horizontal surfaces. An example would be to use vacuum cups coupled to support frame 114 of dual cell fixture 100 on a non-horizontal surface.

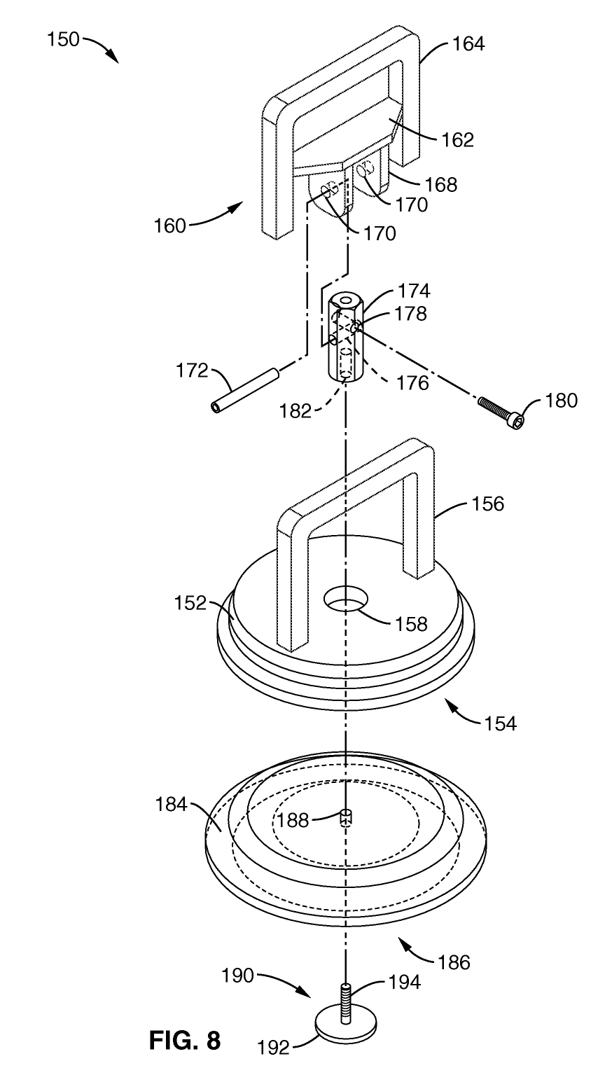

FIG. 8 is an exploded view of one electrode cell 150 of a dual cell EIS system used to measure coating integrity in a field environment. This electrode cell configuration is based on a butterfly handle vacuum cup. Additional vacuum cup configurations as known in the art can be used without departing from the teachings of this invention.

Vacuum cup base 152 has a planar circular disk shape with a lower concave cavity 154 and an upper loop handle 156. Center aperture 158 is through the center of the disk and into cavity 154.

Cam handle assembly 160 comprises an elongated body 162 with an attached loop handle 164 that mates with loop handle 156. Parallel cam ears 166, 168 extend down from body 162 and have corresponding apertures 170 for roll pin 172. Center post 174 has aperture 176 through its diameter to mate with roll pin 172. Threaded aperture 178 in the upper portion of center post 174 accommodates screw 180 which acts as an electric terminal for connections to the cell. Center post 174 also has threaded aperture 182 in the center axis at the bottom. In a preferred embodiment, center post 174 is made from a corrosion resistant material, such as 303 stainless steel.

Vacuum cup base 152 and cam handle assembly 160 are made of non-conductive material with relatively high resistivities compared to the coating to be measured. Materials such as acrylic, plastic or UHMWPE are preferred.

Vacuum pad 184 is composed of a resilient non conducting material such as rubber, silicone rubber or plastic and is configured to fit into concave cavity 154 of vacuum base 152. Vacuum pad 184 also has a concave cavity 186 and a center aperture 188. Electrode 190 consists of round disk 192 and electrode stem 194 that fits tightly through center aperture 188 and has threads at least at the end that mate with threaded aperture 182. Electrode stem 194 is preferably made of a corrosion resistant material, such as 303 stainless steel. Round disk 192 is an appropriate electrode material such as platinum, stainless steel or a platinum plated metal. In one embodiment, electrode 190 consists of a stainless steel round disk 192 that is ⅞ inch in diameter and a stainless steel 8-32 threaded rod 194 that is threaded into a shallow aperture formed in round disk 192 and then TIG welded together.

When assembled and cam handle assembly 160 is positioned perpendicular to vacuum cup base 152, vacuum pad 185 is supported by electrode 190. When cam handle assembly is rotated about 90 degrees and positioned adjacent to upper loop handle 156, electrode 190 pulls vacuum pad 184 up and into cavity 154.

Note that electrode stem 194 can be adjusted to change the position of round disk 192 relative to vacuum cup base 152. This adjustment will change the height of electrode 190 in vacuum pad 185 relative to the adjacent coating. A spacer can also be positioned on electrode stem 194 between round disk 192 and vacuum pad 185 to adjust the height of electrode 190.

An optional coil spring can be placed on electrode stem 194 between vacuum base 152 and vacuum pad 184.

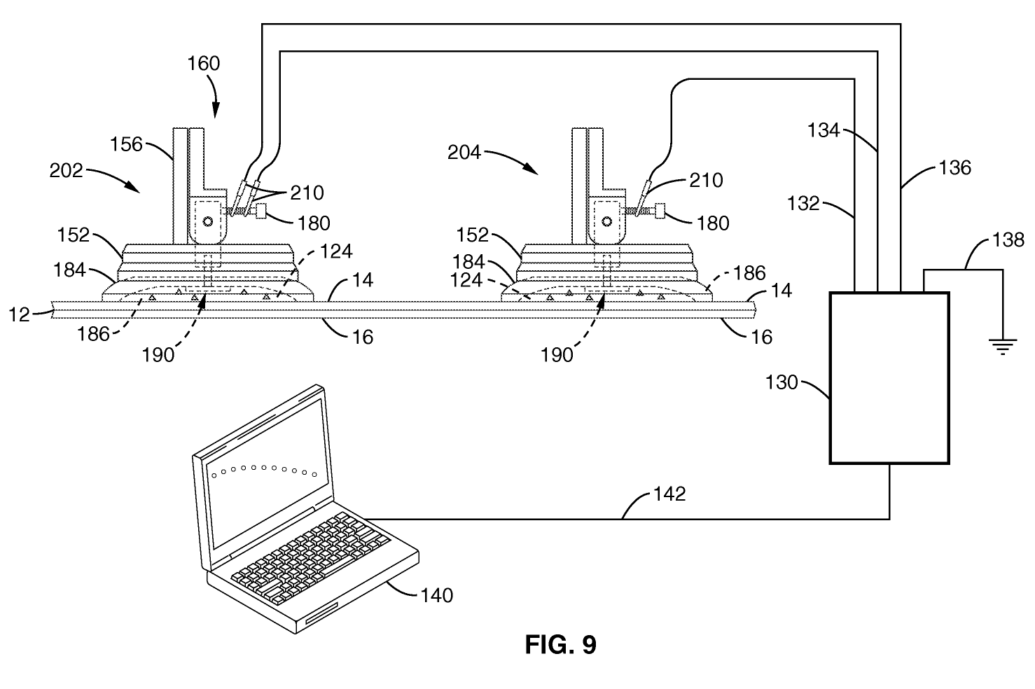

FIG. 9 illustrates dual cell EIS system 200 positioned to measure integrity of coating 14 on panel 12 in the field. Cell 202 is now configured as the counter-reference electrode and cell 204 is configured as the working electrode. An electrolyte gel 124 is placed in the cavity 186 of each vacuum pad 184. When placed in contact with coating 14, the cam handle assembly 160 of each cell 202, 204 is rotated parallel to the loop handle 156 to elevate electrode 190 and cause a vacuum to form between vacuum pad 184 and coating 14 to ensure the electrolyte 124 contacts coating 14. This vacuum coupling ensures an electrical connection between coating 14 and electrode 190. Cells 202, 204 can be secured to any non horizontal or non flat coating location that will support a vacuum cup.

Potentiostat 130 has working electrode lead 132 connected to the terminal 180 on cell 204, with an alligator clip 210 or comparable electrical connection. Counter electrode lead 134 is connected to the electrode in cell 202 through terminal 180 and reference electrode lead 136 is connected to the electrode in cell 202. Potentiostat 130 also has a ground lead 138. In a first mode, potentiostat 130 applies a potential at varying frequencies through working electrode lead 132 and measures the resulting current. In a second mode, potentiostat 130 applies a current through working electrode lead 132 at varying frequencies and measures the resulting potential.

Potentiostat 130 is connected to computer 140 through connection 142. Computer 140 is configured to calculate impedance from the measurements from potentiostat 130 and output the results as a display, such as a Bode plot, equivalent circuit or other analytical format such as electronic data that can be stored in memory and used to interpret the integrity of coating 14. In one mode, a controller card is placed in computer 140 to receive signals through connection 142.

In one example of measuring coatings using the portable dual cell EIS, the paint coating of a vehicle with a fiberglass substrate was compared to the paint coating of a similar vintage vehicle with a steel substrate. The results of these tests showed the low frequency impedance (0.1 Hz) was approximately 10⁹ ohms-cm². In a second example, the impedance of the coating at 0.1 Hz on a vehicle 18 years older than the vehicles in the previous example was 10⁷ ohms-cm². This indicates the coating on the second older vehicle had less integrity than the coating on the first vehicle.

In another embodiment, a strut or frame connects EIS cells 202, 204 to maintain a uniform distance between the cells during testing.

One of ordinary skill in the art will recognize that the electrode configuration of the present invention can also be used for DC resistance measurements and electrochemical noise measurements.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for measuring impedance of a coating on a substrate comprising:
a first cell chamber;
wherein said first cell chamber has a first opening;
a counter-reference electrode positioned in said first cell chamber;
a second cell chamber;
wherein said second cell chamber has a second opening;
a working electrode positioned in said second cell chamber;
an electrolyte positioned in said first, second cell chambers;
wherein said electrolyte is in electrical contact with said counter-reference electrode in said first cell chamber;
wherein said electrolyte is in electrical contact with said working electrode in said second cell chamber;
means for securing said first opening and said second opening to a coating;
wherein said electrolyte makes electrical contact with said coating when said first opening and said second opening are in contact with said coating by said means for securing;
a potentiostat electrically connected to said counter-reference electrode and to said working electrode;
wherein said potentiostat is adapted to apply alternating voltage at varying frequencies to said working electrode and measure current at said counter-reference electrode;
means for calculating impedance from measured current; and
means for outputting impedance.

2. An apparatus as recited in claim 1:
wherein the distance between said counter-reference electrode and the coating is adjustable; and
wherein the distance between said working electrode and the coating is adjustable.

3. An apparatus as recited in claim 1, wherein said counter reference electrode comprises a niobium platinum plated mesh; and
wherein said working electrode comprises a niobium platinum plated mesh.

4. An apparatus as recited in claim 1, wherein said means for securing is adapted to secure said first opening and said second opening to a non-horizontal coating.

5. An apparatus as recited in claim 1, wherein said electrolyte comprises a conductive gel.

6. An apparatus as recited in claim 1, wherein said means for securing comprises:
a frame supporting said first cell chamber and said second cell chamber;
a spring loaded plunger connected to said frame; and
a base connected to said spring loaded plunger;
wherein said base is adapted to support a coated substrate.

7. An apparatus as recited in claim 6, wherein the distance between said first cell chamber and said second cell chamber is adjustable.

8. An apparatus as recited in claim 1, wherein said means for securing comprises:
a first vacuum cup coupled to said reference counter electrode; and
a second vacuum cup coupled to said working electrode.

9. An apparatus as recited in claim 1, further comprising:
wherein said potentiostat is adapted to apply alternating current at varying frequencies to said working electrode;
wherein said potentiostat is further adapted to measure voltage at said counter-reference electrode; and
means for calculating impedance from measured voltage.

10. An apparatus as recited in claim 1:
wherein said first cell chamber comprises a cavity in a first body;
wherein said first opening comprises a first O-ring mounted in said first body;
wherein said second cell chamber comprises a cavity in a second body; and
wherein said second opening comprises a second O-ring mounted in said second body.

11. An apparatus as recited in claim 1:
wherein said first cell chamber comprises a first vacuum cup; and
wherein said second cell chamber comprises a second vacuum cup.

12. An apparatus as recited in claim 11, wherein said counter reference electrode comprises stainless steel; and
wherein said working electrode comprises stainless steel.

13. An apparatus for measuring the impedance of a coating on a substrate comprising:
a first vacuum cup having a first cavity;
a counter-reference electrode positioned in said first cavity;
a second vacuum cup having a second cavity;
a working electrode positioned in said second cavity;
an electrolyte positioned in said first, second cavities;
said electrolyte adapted to conduct electricity between a coating and an electrode;
a potentiostat electrically connected to said counter-reference electrode and said working electrode;
wherein said potentiostat is adapted to apply alternating current at varying frequencies to said working electrode and measure potential at said counter-reference electrode;
means for calculating impedance from measured potential; and
means for outputting impedance.

14. An apparatus as recited in claim 13, wherein said first, second vacuum cups are adapted to couple to a non-horizontal coating.

15. An apparatus as recited in claim 13, wherein said electrolyte comprises a conductive gel.

16. An apparatus as recited in claim 13, further comprising:
wherein said potentiostat is adapted to apply alternating voltage at varying frequencies to said working electrode;
wherein said potentiostat is further adapted to measure current at said counter-reference electrode; and
means for calculating impedance from measured current.

17. An electrode cell for measuring impedance of a coating on a substrate comprising:
a planar vacuum cup base having a first aperture;
a resilient vacuum pad having first and second sides, said first side adapted to mate with said planar vacuum cup base;
said second side of said vacuum pad having a concave cavity;
a second aperture in said vacuum pad adapted to align with said first aperture;
an electrode comprising a disk and perpendicular stem;
said disk of said electrode adapted to fit inside said concave cavity of said vacuum pad;
said stem of said electrode adapted to fit in said first aperture and said second aperture;
wherein said stem is further adapted to couple said vacuum pad to said vacuum base;
said stem adapted to electrically connect to a potentiostat;
an electrolyte positioned in said concave cavity;
said electrolyte adapted to conduct electricity between a coating and said electrode;
wherein when said concave cavity of said vacuum pad containing said electrolyte is positioned on a coating, said electrode makes electrical contact with the coating through said electrolyte.

18. An electrode cell as recited in claim 17, wherein moving said electrode away from said coating relative to said vacuum cup base forms a vacuum between said concave cavity and said coating.

19. An electrode cell as recited in claim 18, wherein said vacuum pad is adapted to releasably couple to a non-horizontal coating.

20. An electrode cell as recited in claim 17, wherein said electrolyte comprises a conductive gel.

21. A method for measuring impedance of a coating on a substrate comprising:
providing a first electrode chamber having a counter-reference electrode and an electrolyte in said chamber;
providing a second electrode chamber having a working electrode and an electrolyte in said chamber;
providing a potentiostat adapted to apply alternating voltage at varying frequencies to said working electrode and measure current at said counter-reference electrode;
coupling said first and second electrode chamber to a coating wherein said electrolyte makes electrical contact with said coating;
applying alternating voltage at varying frequencies to said working electrode;
measuring current at said counter-reference electrode;
calculating impedance from said measured current; and
outputting impedance to interpret coating integrity.

22. A method as recited in claim 21, wherein said counter reference electrode comprises a niobium platinum plated mesh; and
wherein said working electrode comprises a niobium platinum plated mesh.

23. A method as recited in claim 21:
wherein said potentiostat is adapted to apply alternating current at varying frequencies to said working electrode and measure voltage at said counter-reference electrode;
measuring voltage at said counter reference electrode; and
calculating impedance from said measured voltage.

24. A method as recited in claim 21, further comprising coupling said first, second chamber to a non-horizontal coating.

25. A method as recited in claim 21:
wherein said first electrode chamber comprises a first vacuum cup; and
wherein said second electrode chamber comprises a second vacuum cup.

26. An apparatus as recited in claim 25, wherein said counter reference electrode comprises stainless steel; and
wherein said working electrode comprises stainless steel.

27. A method as recited in claim 21, wherein said electrolyte comprises a conductive gel.
